(19) United States
(12) Patent Application Publication
(10) Pub. No.: US 2012/0016620 A1
(43) Pub. Date: Jan. 19, 2012

(54) SYSTEM AND METHOD FOR TESTING AN OBJECT USING A MECHANICAL ARM

(75) Inventors: SHEN-CHUN LI, Tu-Cheng (TW); HSIEN-CHUAN LIANG, Tu-Cheng (TW); WEN-LAING TSENG, Tu-Cheng (TW); YUNG-CHIEH CHEN, Tu-Cheng (TW); YU-CHANG PAI, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 12/978,418

(22) Filed: Dec. 24, 2010

(30) Foreign Application Priority Data
Jul. 16, 2010 (TW) 99123382

(51) Int. Cl. G06F 19/00

(52) U.S. Cl. 702/121

(57) ABSTRACT

A system and method for testing objects using a mechanical arm includes establishing coordinate system based on a work area of the mechanical arm, and obtaining test parameters from a storage system. The method further includes controlling the mechanical arm to get an object and position the object to the position of a test platform according to the test parameters, controlling the mechanical arm to get test tool from a tool shelf and position the test tool to a position of test point on the object to test the object according to the test parameters. The method also includes controlling the mechanical arm to get the object from the test platform and position the object to the location reserved for the object according to the test parameters.

### BACKGROUND

1. Technical Field

Embodiments of the present disclosure relate to testing technology, and more particularly to a system and a method for testing an object using a mechanical arm.

2. Description of Related Art

A mechanical arm may be used to test an object. Generally, when using the mechanical arm to test the object, people have to position the object on a test platform, and take away the object from the test platform when testing is finished. Therefore, improvements are desirable to improve the testing process.

### BRIEF DESCRIPTION OF THE DRAWINGS

FIG. 1 is a block diagram of one embodiment of a computing device including a test system.

FIG. 2 is a block diagram showing one embodiment of functional modules of the test system of FIG. 1.

FIG. 3 is a flowchart of one embodiment of a method for testing an object using a mechanical arm.

FIG. 4 is a flowchart of one embodiment of details of block S12 of FIG. 3.

FIG. 5 is a flowchart of one embodiment of details of block S13 of FIG. 3.

FIG. 6 is a flowchart of one embodiment of details of block S14 of FIG. 3.

### DETAILED DESCRIPTION

The processes described may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

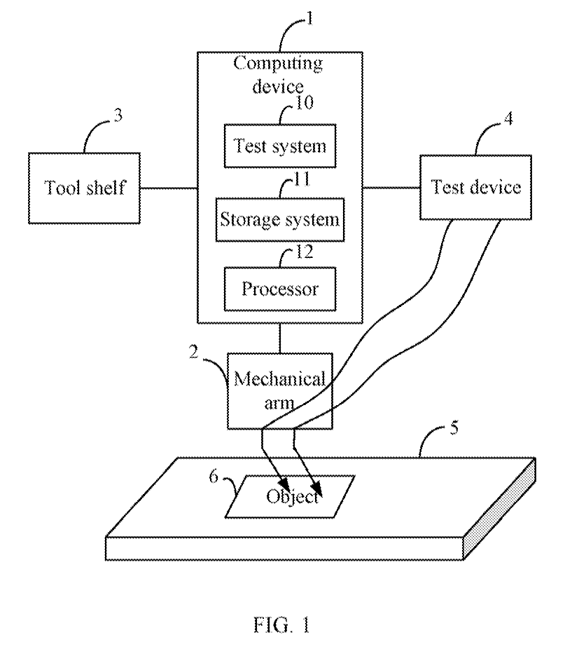

FIG. 1 is a block diagram of one embodiment of a computing device 1 including a test system 10. The test system 10 may be used to test objects using a mechanical arm 2 connected to the computing device 1. In some embodiments, the mechanical arm 2 may test voltage of the objects, or size of the objects, for example. The object 6 is positioned on a test platform 5, the object 6 may be a printed circuit board (PCB), for example, but the disclosure is not limited thereto. In one embodiment, the computing device 1 is further connected to a tool shelf 3, and a test device 4. Test tools for testing the object, such as probes, and holder tools for holding the object, such as a vacuum tool may be placed on the tool shelf 3. In one embodiment, the tool shelf 3 may rotate around its axis, to adjust position of a tool relative to the mechanical arm 2. The test device 4 collects test data of the object 6 and sends the test data to the computing device 1. In one embodiment, the test device 4 may be a time domain reflectometer (TDR), for example.

The computing device 1 includes a storage system 11 and at least one processor 12. The storage system 11 stores various data, such as test parameters. In one embodiment, the test parameters may include, but are not limited to coordinates of an original location of the objects to be tested, coordinates of the test platform 5, coordinates of the tool shelf 3, coordinates of each test point on the object when the object is positioned on the platform 5, and coordinates of a location reserved for object.

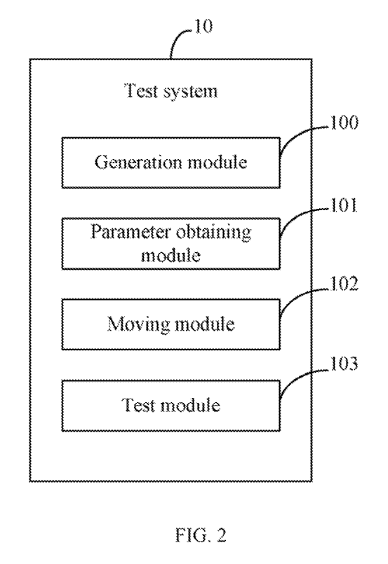

FIG. 2 is a block diagram of the test system 10 of FIG. 1. In one embodiment, the test system 10 may include a generation module 100, a parameter obtaining module 101, a moving module 102, and a test module 103. In some embodiments, the modules 100, 101, 102, and 103 may comprise computerized code in the form of one or more programs that are stored in the first storage system 102 (or memory). The computerized code includes instructions that are executed by the at least one processor 12 to provide functions for modules 100, 101, 102, and 103.

The generation module 100 establishes a coordinate system based on a work area of the mechanical arm 2, and positions the mechanical arm 2 at a predetermined initial location. The coordinate system may include an x-axis, a y-axis, and/or a z-axis, for example. In one embodiment, the initial location is the origin of the coordinate system. The work area is a range of movement of the mechanical arm 2.

The parameter obtaining module 101 obtains the test parameters from the storage system 11. As mentioned above, the test parameters include the coordinates of the original location of the objects to be tested, the coordinates of the test platform 5, the coordinates of the tool shelf 3, the coordinates of the test points on the object to be tested when the object is positioned on the platform 5, and the coordinates of the location reserved for object.

The moving module 102 controls the mechanical arm 2 to get an object 6 to be tested according to the coordinates of the original location of the objects to be tested, and position the object 6 on the test platform 5 according to the coordinates of the test platform 5.

The test module 103 controls the mechanical arm 2 to get probes from the tool shelf 3 according to the coordinates of the tool shelf 3, and to position the probes on each test point of the object 6 to test the object 6.

The moving module 102 further controls the mechanical arm 2 to get the object 6 from the test platform 5 according to the coordinates of the test platform 5 if testing of the object 6 is completed, and to position the object 6 at the location reserved for object according to the coordinates of the reserved location.

The moving module 102 further controls the mechanical arm 2 to move to the initial position.

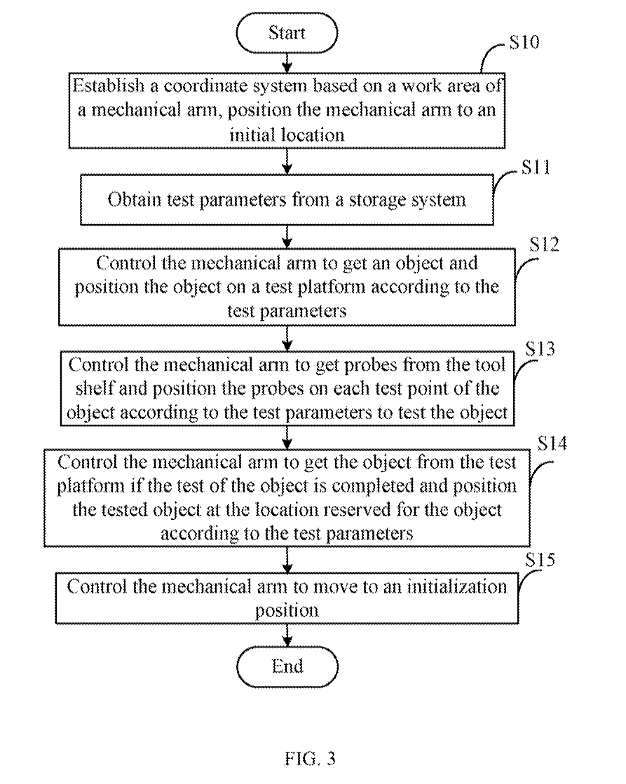

FIG. 3 is a flowchart of one embodiment of a method for testing an object using the mechanical arm 2. Depending on the embodiment, additional blocks may be added, others removed, and the ordering of the blocks may be changed.

In block S10, the generation module 100 establishes a coordinate system based on the work area of the mechanical arm 2, and positions the mechanical arm 2 at an initial location. In one embodiment, the origin of the coordinate system is the initial location of the mechanical arm 2.

In block S11, the parameter obtaining module 101 obtains test parameters from the storage system 11.

In block S12, the moving module 102 controls the mechanical arm 2 to get an object 6 according to the coordinates of the original location of the objects, and to position the object 6 on the test platform 5 according to the coordinates of the test platform 5.

In block S13, the test module 103 controls the mechanical arm 2 to get probes from the tool shelf 3 according to the coordinates of the tool shelf 3. In this embodiment the mechanical arm 2 is able to get up to two probes at the same time, and to position the probes on corresponding test points of the object according to the coordinates of the test points when the object is positioned on the test platform 5. Once a test point has the corresponding probe contacted thereto, testing is performed.

In block S14, the moving module 102 then controls the mechanical arm 2 to get the object 6 from the test platform 5 according to the coordinates of the test platform 5, and to move the object to the location reserved for object according to the coordinates of the reserved location.

In block S15, the moving module 102 further controls the mechanical arm 2 to move to the initial position.

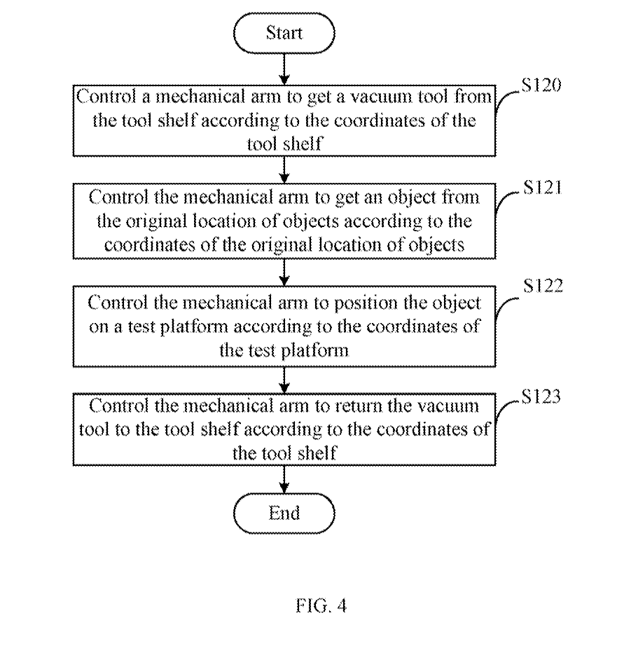

FIG. 4 is a flowchart of details of block S12 of FIG. 3.

In block 5120, the moving module 102 controls the mechanical arm 2 to get a vacuum tool from the tool shelf 3 according to the coordinates of the tool shelf 3.

In block 5121, the moving module 102 controls the mechanical arm 2 with the vacuum tool to get an object 6 from the original location of objects according to the coordinates of the original location of objects.

In block S122, the moving module 102 controls the mechanical arm 2 with the vacuum tool and the object 6 to position the object 6 on the test platform 5 according to the coordinates of the test platform 5.

In block S123, the moving module 102 controls the mechanical arm 2 with the vacuum tool to return the vacuum tool to the tool shelf 3 according to the coordinates of the tool shelf 3.

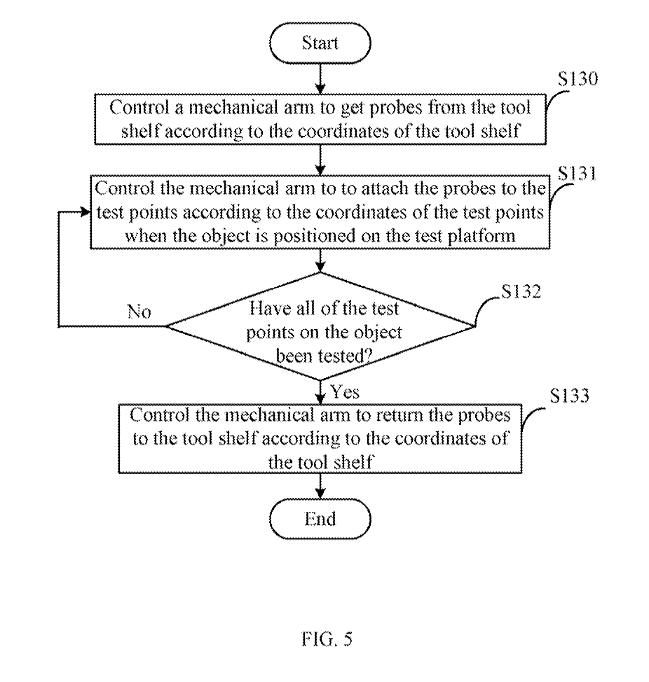

FIG. 5 is a flowchart of details of block S13 of FIG. 3.

In block S130, the test module 103 controls the mechanical arm 2 to get probes from the tool shelf 3 according to the coordinates of the tool shelf 3.

In block S131, the test module 103 controls the mechanical arm 2 to attach the probes to the test points according to the coordinates of the test points when the object 6 is positioned on the test platform 5.

In block S132, the test module 103 determines whether probes have been attached to all of the test points. If there are test points on the object need to be tested, the procedure goes back to block S131.

If all of the test points on the object have been tested, in block S133, the test module 103 controls the mechanical arm 2 to return the probes to the tool shelf 3 according to the coordinates of the tool shelf 3.

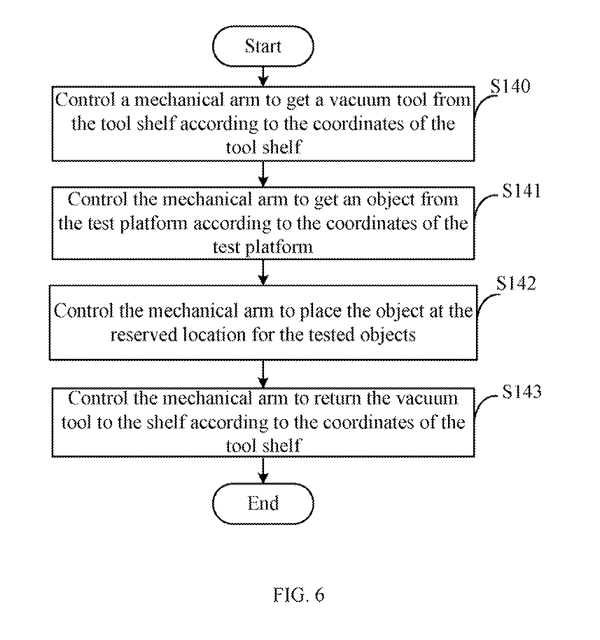

FIG. 6 is a flowchart of details of block S14 of FIG. 3.

In block S140, the moving module 102 controls the mechanical arm 2 to get a vacuum tool from the tool shelf 3 according to the coordinates of the tool shelf 3.

In block S141, the moving module 102 controls the mechanical arm 2 with the vacuum tool to get the object 6 from the test platform 5 according to the coordinates of the test platform 5.

In block S142, the moving module 102 controls the mechanical arm 2 with the vacuum tool and the object 6 to place the object 6 at the reserved location for the object.

In block S143, the moving module 102 controls the mechanical arm 2 with the vacuum tool to return the vacuum tool to the shelf 3 according to the coordinates of the tool shelf 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, the computing system in communication with a mechanical arm, and a tool shelf, the computing device comprising:
a storage system to store test parameters; and
at least one processor to execute one or more programs stored in the storage system, the one or more programs comprising:
a generation module operable to establish a coordinate system based on a work area of the mechanical arm, and position the mechanical arm at an initial location;
a parameter obtaining module operable to obtain the test parameters from the storage system;
a moving module operable to control the mechanical arm to get an object from an original location of the object and position the object on a test platform according to the test parameters;
a test module operable to control the mechanical arm to get test tool from the tool shelf and position the test tool on each test point of the object to test the object according to the test parameters; and
the moving module operable to control the mechanical arm to get the object from the test platform and position the object to the location reserved for the object according to the test parameters if the testing is completed, and control the mechanical arm to move to the initial location.

2. The computing device of claim 1, wherein the initial location is the origin of the coordinate system.

3. The computer device of claim 1, wherein the test parameters comprise coordinates of the original location of the object, and coordinates of a location reserved for the object, coordinates of the test platform, coordinates of the tool shelf, and coordinates of each test point on the object when the object is positioned on the test platform.

4. The computing device of claim 3, wherein the moving module controls the mechanical arm to get a holder tool for holding the object from the tool shelf according to the coordinates of the tool shelf, controls the mechanical arm with the holder tool to get the object from the original location according to the coordinates of the original location, controls the mechanical arm with the holder tool and object to position the object on the test platform according to the coordinates of the test platform, controls the mechanical arm with the holder tool to return the holder tool to the tool shelf according to the coordinates of the tool shelf.

5. The computing device of claim 3, wherein the test module controls the mechanical arm to get a test tool for testing the object from the tool shelf according to the coordinates of the tool shelf, controls the mechanical arm with the test tool to attach the test tool on the test point of the object, controls the mechanical arm with the test tool to position the test tool to the tool shelf according to the coordinates of the tool shelf if all of the test points on the object have been tested.

6. The computing device of claim 3, wherein the moving module further controls the mechanical arm to get a holder tool from the tool shelf according to the coordinates of the tool shelf, controls the mechanical arm with the holder tool to get the object from the test platform according to the coordinate of the test platform, controls the mechanical arm with the holder tool and the object to position the object to the location reserved for the object according to the coordinates of the location reserved for the object, controls the mechanical arm with the holder tool to return the holder tool to the location of the tool shelf according to the coordinates of the location of the tool shelf.

7. A computer-implemented method for testing an object using a mechanical arm by a computing device comprising a storage system, the computing device in communication with the mechanical arm and a tool shelf, the method comprising:
(a) establishing coordinate system based on a work area of the mechanical arm, and position the mechanical arm at an initial location;
(b) obtaining the test parameters from the storage system;
(c) controlling the mechanical arm to get an object from an original location of an object and position the object on a test platform according to the test parameters;
(d) controlling the mechanical arm to get test tool from the tool shelf and position the test tool on each test point of the object to test the object according to the test parameters; and
(e) controlling the mechanical arm to get the object from the test platform and position the object to the location reserved for the object according to the test parameters;
(f) controlling the mechanical arm to move to the initial position.

8. The method of claim 7, wherein the initial location is the origin of the coordinate system.

9. The method of claim 7, wherein the test parameters comprise coordinates of the original location of the object, coordinates of a location reserved for the object, coordinates of the test platform, coordinates of the tool shelf, and coordinates of each test point on the object when the object is positioned on the test platform.

10. The method of claim 9, wherein the step (c) further comprising:
controlling the mechanical arm move to get a holder tool for holding the object from the tool shelf according to the coordinates of the tool shelf;
controlling the mechanical arm with the holder tool to get the object from the original location according to the coordinates of the original location;
controlling the mechanical arm with the holder tool and object to position the object on the test platform according to the coordinates of the test platform;
controlling the mechanical arm with the holder tool to position the holder tool to the tool shelf according to the coordinates of the tool shelf.

11. The method of claim 9, wherein the step (d) further comprising:
controlling the mechanical arm to get a test tool for testing the object from the tool shelf according to the coordinates of the tool shelf;
controlling the mechanical arm with the test tool to attach the test tool on the test point of the object;
controlling the mechanical arm with the test tool to position the test tool to the tool shelf according to the coordinates of the tool shelf if all of the test points on the object have been tested.

12. The method of claim 9, wherein the step (e) further comprising:
controlling the mechanical arm to get a holder tool from the tool shelf according to the coordinates of the tool shelf;
controlling the mechanical arm with the holder tool to get a object from the test platform according to the coordinate of the test platform;
controlling the mechanical arm with the holder tool and the object to position the object to the location reserved for the object according to the coordinates of the location reserved for the object;
controlling the mechanical arm with the holder tool to return the holder tool to the location of the tool shelf according to the coordinates of the location of the tool shelf.

13. A storage medium having stored thereon instructions that, when executed by a processor of a computing device, causes the computing device to perform a method for testing an object using a mechanical arm comprising a storage system, the computing device in communication with the mechanical arm and a tool shelf, the method comprising:
(a) establishing coordinate system based on a work area of the mechanical arm, and position the mechanical arm at an initial location;
(b) obtaining the test parameters from the storage system;
(c) controlling the mechanical arm to get an object from an original location of an object and position the object on a test platform according to the test parameters;
(d) controlling the mechanical arm to get test tool from the tool shelf and position the test tool on each test point of the object to test the object according to the test parameters; and
(e) controlling the mechanical arm to get the object from the test platform and position the object to the location reserved for the object according to the test parameters;
(f) controlling the mechanical arm to move to the initial position.

14. The medium of claim 13, wherein the initial location is the origin of the coordinate system.

15. The medium of claim 13, wherein test parameters comprise coordinates of the original location of the object, coordinates of a location reserved for the object, coordinates of the test platform, coordinates of the tool shelf, and coordinates of each test point on the object when the object is positioned on the test platform.

16. The medium of claim 15, wherein the step (c) further comprising:
controlling the mechanical arm move to get a holder tool for holding the object from the tool shelf according to the coordinates of the tool shelf;
controlling the mechanical arm with the holder tool to get the object from the original location according to the coordinates of the original location;
controlling the mechanical arm with the holder tool and object to position the object on the test platform according to the coordinates of the test platform;
controlling the mechanical arm with the holder tool to position the holder tool to the tool shelf according to the coordinates of the tool shelf.

17. The medium of claim 15, wherein the step (d) further comprising:
controlling the mechanical arm to get a test tool for testing the object from the tool shelf according to the coordinates of the tool shelf;
controlling the mechanical arm with the test tool to attach the test tool on the test point of the object;
controlling the mechanical arm with the test tool to position the test tool to the tool shelf according to the coordinates of the tool shelf if all of the test points on the object have been tested.

18. The medium of claim 15, wherein the step (e) further comprising:
controlling the mechanical arm to get a holder tool from the tool shelf according to the coordinates of the tool shelf;
controlling the mechanical arm with the holder tool to get a object from the test platform according to the coordinate of the test platform;
controlling the mechanical arm with the holder tool and the object to position the object to the location reserved for the object according to the coordinates of the location reserved for the object;
controlling the mechanical arm with the holder tool to return the holder tool to the location of the tool shelf according to the coordinates of the location of the tool shelf.
